(19) United States
(12) Patent Application Publication
(10) Pub. No.: US 2005/0218223 A1
(43) Pub. Date: Oct. 6, 2005

(54) Method of tracking helicopter parts

(76) Inventors: Matthew P. Pasulka, Fairfield, CT (US); Frank J. Kuzminski, West Point, NY (US)

Correspondence Address: Matthew P. Pasulka;Sikorsky Aircraft Corporation, Legal-IP Dept., Mail Stop S316A, 6900 Main Street, Stratford, CT, 06615-6649, US

(21) Appl. No.: 10/815,259

(22) Filed: Mar. 31, 2004

(51) Int. Cl. G06F 17/60

(52) U.S. Cl. 235/385

(57) ABSTRACT

A part tracking system has a tester and a part tracking device. The part tracking device is an electronic device that identifies the part with a unique signal. The part tracking device has a power source or an inductor which is connected to a filter. The filter is connected to a signal generator that creates a signal and sends the signal to a testing unit to determine whether the correct signal was created by the part tracking device.

### BACKGROUND OF THE INVENTION

1. Technical Field

This invention generally relates to helicopter maintenance. More specifically, this invention relates to a system for tracking helicopter parts electronically.

2. Background of the Invention

Throughout the development of the helicopter, the manufacturers of helicopters have tried to make their helicopters safer by providing accurate predictions as to the quality of components in a helicopter. Currently, when a helicopter is built, key parts are serial numbered so that the part may be tracked throughout the life cycle of the part and helicopter. This serial numbering is designed to ensure that only components complying with FAA or military specifications are ever installed on an aircraft.

Often, in an effort to reduce costs, the operator/maintenance personnel of the helicopter attempt to purchase and install replacement parts from other than approved sources. Additionally, there are many businesses that attempt to repair the helicopter parts and resell them regardless of the quality. In both cases, the quality of the parts are insufficient to meet the required flight specifications thus often making the helicopter regulatorily unflyable. Another shortcoming of the prior art system is that even the most detailed serial numbering system does not prevent forgeries. Currently, companies are offering types of infrared micro marking to help deter counterfeiting, although it may be expensive to reproduce similar markings it is not impossible.

This fraud costs aerospace equipment manufacturers millions of dollars every year in damage to reputation, lawsuits against OEMs for non-OEM parts, additional maintenance costs because of unforeseen problems with counterfeit parts, loss of equipment and loss of life. Additionally, helicopter manufacturers must investigate many defective part claims only to discover after spending hundreds of thousands of dollars on forensic research, that the part was not manufactured by the helicopter manufacturer or its suppliers. In some cases, because of the delay in finding the claimed defective part was not an OEM part, an aggrieved party files a lawsuit against the manufacturer until the OEM proves otherwise.

Another shortcoming of the prior art is that in order to ensure that there are not any grey market goods or black market goods, the OEM must constantly audit and enforce its intellectual property. With the high costs of audits for all parts suppliers, a need for limiting these costs clearly exists. Additionally, with the average price of a patent infringement lawsuit soaring above $1.5 million, not including the loss of a corporations focus on its core business, the loss of managers time and the alienation of suppliers, a less onerous solution is sought.

A need therefore exists for an improved part marking and part tracking system for aircraft.

### SUMMARY OF THE INVENTION

The present invention overcomes the foregoing disadvantages of the prior art by providing a method of tracking helicopter parts electronically.

Accordingly, it is an object of the present invention to provide a method of tracking which helicopter parts were produced by certified helicopter part manufacturers.

It is another object of this invention to reduce the transaction cost of tracing grey market goods.

It is still another object of this invention to reduce litigation costs.

Yet another object of the invention is to provide a method of tracking electronic helicopter parts that is tamper resistant.

Another object of the invention is to provide a method of reducing the risk that the helicopter part was involved in a crash.

Still yet another object of the invention is to provide a method for better predicting failure rates of equipment.

And another object of the invention is to provide a method for predicting the life of a component.

Theses and other objects of the present invention are achieved by providing a method of tracking electronic helicopter components. The method comprises providing a part tracking device, affixing the part tracking device to a part, monitoring the electronic circuit, resisting removal and reapplication to another component.

Additional objects and advantages of the invention are set forth in the detailed description herein, or will be apparent to those of ordinary skill in the art. Also it should be appreciated that modifications and variations to the specifically illustrated and discussed embodiments and uses of this invention may be practiced without departing from the spirit and scope thereof, by virtue of present reference thereto. Such variations may include but are not limited to, substitution of method steps, method steps with equivalent actions, or multiple steps so that the method functions in a similar manner to that which is disclosed. Addtionally, variations of devices may include but are not limited to, substitution of parts, parts with equivalent functions, or multiple parts so that the devices/parts functions in a similar manner to that which is disclosed.

For a fuller understanding of the nature and objects of the invention, reference should be made to the following detailed description, which illustrate, by way of example, the principles of the invention.

### BRIEF DESCRIPTION OF THE DRAWINGS

The preferred embodiment of the invention, illustrative of the best mode in which the applicants have contemplated applying the principles, are set forth in the following description and shown in the drawings and are particularly and distinctly pointed out and set forth in the appended claims.

Similar numerals refer to similar parts throughout the drawings.

FIG. 1 is a comparative drawing of signals as an output of a part tracking device;

FIG. 2 is a schematic drawing of select components of a part tracking system; and

FIG. 3 is a decision tree of a helicopter integrated part tracking system.

### DESCRIPTION OF THE PREFERRED EMBODIMENT

The detailed description of the present invention is given for exemplary purposes. It will be apparent to those skilled in the art that numerous changes and modifications can be made without departing from the scope of the invention. Accordingly, the whole of the description is to be construed in an illustrative and not a limitative sense. The scope of the present invention is to be limited only to the extent of the claims that follow.

The Federal Aviation Administration (FAA) has imposed nearly countless regulations on the abilities of companies to make, manufacture, fabricate, assemble and fly aircraft. It is incumbent on the Original Equipment Manufacturers (OEMs) to ensure that all parts meet the FAA regulations and that those parts are installed according to FAA Standards. Many OEMs also create more stringent standards to insure the quality of their products. For example, Sikorsky Aircraft Corporation produces standards called Sikorsky Standards that are specific instructions regarding the manufacture and assembly of different helicopter components.

In order to ensure that only the parts that meet the FAA regulations, a tamper resistant or unique fingerprint part tracking method and devices must be employed. In order to have a system for tracking aircraft parts, an initial decision must be made by the manufacturer. The choice is simply whether the system and devices would be wired, wireless or a mixture thereof. There are advantages and disadvantages to each system, but each are within the scope of this invention.

One system for tracking parts is a wireless system. This may be accomplished in any number of ways. One way this may be done is through a magnetic field. By placing the part with a created magnetic field the magnetic field is disturbed. Based on the type of disturbance and the position of the disturbance, the system can determine the parts present within the field. The wireless system has significant advantages where the likelihood of interference with the magnetic field is minimal and the practical nature of wiring a tracking system is difficult. One of these locations would be the blades and rotors of a helicopter. By sealing an object that is able to distort a magnetic field in a predictable manner, for example, within the blade, one could create a unique fingerprint that could only be discovered by destructive testing of the part or through inefficient hit or miss testing of substitute parts. Additionally, with the advent of more and more composite parts it is possible to have the embedded object being the only real distortion to the magnetic field.

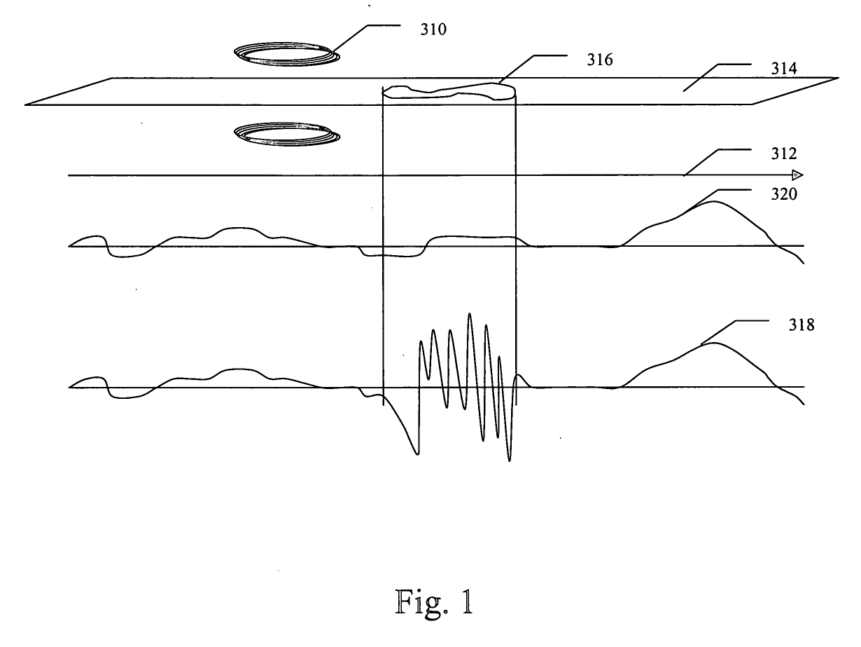

More specifically, referring to FIG. 1, one can see a helicopter blade 314 with an embedded object 316 arbitrarily positioned with the blade. A magnetic field detector 310 is used to scan the parts, in this case the blade. The magnetic field detector could simply comprise two parallel coils of which one of the coils is electrified creating a magnetic field, whereas the second coil picks up the induced electrical signal created by the magnetic field created by the first electric coil. By creating relative movement between the magnetic field detector and the part, preferably having the part being scanned passed between the two coils, the output of the magnetic field detector creates a baseline signal 320. When embedded object 316 is placed within the blade 314 and the same procedure is conducted, a distorted signal 318 is generated. The distorted signal is a function of many variables including the number of coils in the magnetic field detector, the space between the coils 308, the strength of the field, the size of the embedded object 316, the shape of the embedded object 316, the position of the embedded object and the relative position of the magnetic field detector 310. All of these pieces of information should be considered proprietary and protected as such. By keeping them as proprietary it is very difficult and financially prohibitive to reverse engineer the distorted signal 318 because of the many variables involved in producing the distorted signal 318. Therefore, this embodiment meets the objectives of the invention by creating a virtually unique identification for tracking tracks parts.

Additionally, this method and device would be valuable in checking damage to a part. For instance, in the example of a blade, if a blade were struck by lighting and there was damage to the embedded object where the damage would result in a change in the distorted signal when the blade with the damaged embedded object inside the part is tested. This method is ideal for detecting internal damage to parts that is not visible from external inspection and some other types of testing.

After a part is passed through the magnetic field detector, the distorted signal is processed, typically filtered to remove noise or other undesirable signal characteristics. The processed distorted signal is stored in a database for future reference. When a part needs to be verified, the same test under similar conditions is conducted on the part. The test produces a tested signal that may be modified as appropriate. The tested signal is compared with the processed distorted signal. If the tested signal is within a given tolerance of the processed distorted signal, the two signals are said to be equal and the tested part is considered to be the part with the embedded object. If the tested signal is outside an acceptable tolerance level of the first, then the two signals are considered to be different.

It is important to note that it is unnecessary to create a specific magnetic distortion, rather, it is more important to be able to recognize the individual signature of each part as it passes through the magnetic field.

Another way of adding a low cost additional layer of security to the serial numbering process is to add an electronic part tracking system is to put multiple serial numbers on each part. The first part would be one described above and the second one could be a serial number on the case of each electronic serial number.

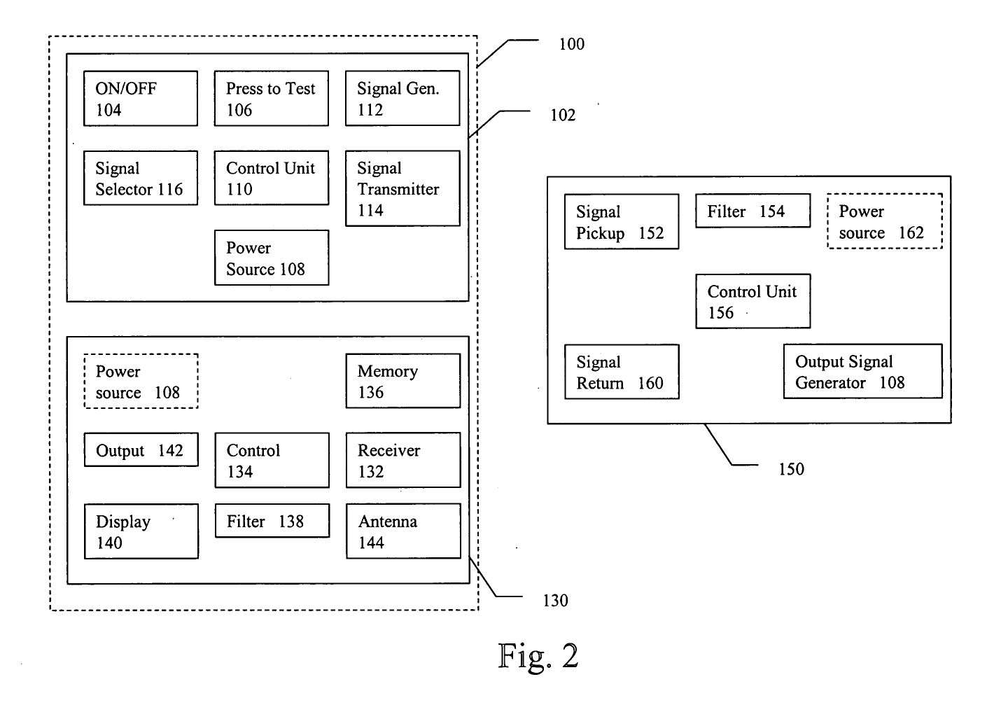

Referring to FIG. 2, which shows a block diagram of an electromagnetic part tracking system, there is a tester 100, that is preferably portable, comprising a generator 102 and processor 130. The generator 102 and processor 130 may be in the same case or in separate cases. A power source 108 is connected to the control unit 110. The control unit is turned on and off with on/off switch 104, which allows power to energize the generator 102, and supplies power to the control unit 110, signal generator 112 and signal transmitter 114.

The control unit 110 may be a CPU or other chip or chipset arrangement. Its primary function is to control the operation of the generator in that it controls the creation of a signal to query the part tracking device. Preferably, the CPU is connected to memory that stores information about the part tracking signals to send to the part tracking device and the methods to generate them.

After the generator 102 is switched on, the control unit 110 is powered up. In a preferred embodiment of the invention there is a signal selector 116 which allows the operator to select a specific signal with which the operator can query the part tracking device 150. Once the signal to query the part tracking device is selected, the control unit 110 signals the signal generator 112 to generate the signal. The signal is sent to a signal transmitter 114 which sends the signal to the part tracking device 150. In one embodiment of the invention, the signal transmitter sends the signal over radio frequencies. The frequencies could be AM, FM, phase modulated or other means. In other embodiments, the signal transmitter 114 sends the signal to the part tracking device 150 through direct connection and in the preferred embodiment, through magnetic fields, preferably with the use of inductors.

Generically, the part tracking device 150 is designed to receive an input signal from the generator 102, process it and return an output signal to the processor 130. There are an infinite number of ways to process the signal to modify it but any hard to predict algorithm will suffice to modify the input signal. The input signal is modified by the algorithm of the part tracking device. The modification of the signal should be unpredictable so that it is not easily reverse engineered. This does not necessary mean that it is impossible to reverse engineer the part tracking device and system, but the cost to do so should deter most attempts to duplicate it and make unauthorized part tracking devices and testers. It should be understood that the processed signal or output signal from the part tracking device need not be unique, only that it be prohibitively expensive to reverse engineer or find a way of duplicating an acceptable output response in a predictable or reliable method. The preferred modification is that the output response for the input signal is not obvious and is preferably unique for any given input. By constructing the part tracking device 150 to process a signal in a unpredictable manner, the objects of the invention are met. Another way of making the part tracking device is to have it only respond with a positive answer upon a specific query. All other queries result in no meaningful response.

The part tracking device 150 is preferably a magnetic field activated device, but it also may be a hardwired or radio frequency based device. In the case of a magnetic field activated device, the part tracking device is magnetically linked to the generator 102 preferably through a signal pickup 152 such as an inductor. The signal is preferably filtered with filter 154 so that there is a clean input signal to be processed through the part tracking device. The signal is processed creating a response in output signal generator 158. The signal is then sent to the signal return 160. The signal return may be another inductor, or a transmitter or hardwire connection to the processor.

The radio frequency part tracking device shown in FIG. 2 is similar to the magnetic field part tracking device described above in that it accomplishes the same function; however, certain key elements would be present. Signal pickup 152 preferably is an antenna connected to a receiver and if necessary an amplifier. In this embodiment, it is preferred that there is a power source 162 for the part tracking device to amplify the signal received in the signal pickup 152. The power source is preferably a long life battery that may be replaceable as needed. The signal generator 158 and signal return 160 may be the same as described above.

Finally, if the generator is directly connected to the part tracking device, the need from signal transmitter 114 and any kind of superfluous antenna, filters, transmitters, power supplies and receivers can be removed from the device.

The processor 130 depends on the type of signal return 160 used in part tracking device 150. Therefore, if the part tracking device is configured for a direct link to the processor 130, the processor is configured to receive a signal from the part tracking device 130. Similarly, if the part tracking device 150 transmits its output signal over radio frequencies, the processor should have an antenna and receiver to pick up the output signal.

For example if the processor is RF, preferably it has an antenna and receiver 132, a control unit 134, memory 136 for storing information signal information, a filter 138, a display for displaying results, and an output 142. The output device could be a kind of electronic storage device including hard drive, disk drive, modem connection, or other connection.

The part tracking device should be permanently affixed to different parts so that any attempted removal would result in the part tracking device. The tester is preferably hand held. Preferably tester has the generator and the processor is in a single housing. The tester is put in proximity to the part tracking device and the tester is activated sending a signal to the part tracking device. The part tracking device responds sending a signal to the processor which compares the response received to the response expected. If the two signals are the same the positive result is displayed or outputted by the processor. If the signals are different or if there is no response from the part tracking device, preferably the tester will requery the part tracking device at least once. If the response is again different or non-existent, the tester will output or display that information.

Preferably, the part tracking devices hold additional information about the part, such as date of manufacture, date of replacement, next service date, type of service, type of part and the airframe on which it was installed.

This part tracking system may be integrated into a helicopter to provide an additional layer of safety on the helicopter. Preferably, the part tracking devices would be integrated on parts deemed to be critical, high value, or high wear parts. The tester would be integrated into the helicopter preferably into the central computer so that the helicopter performs the part tracking devices check as part of its start up or operation procedures.

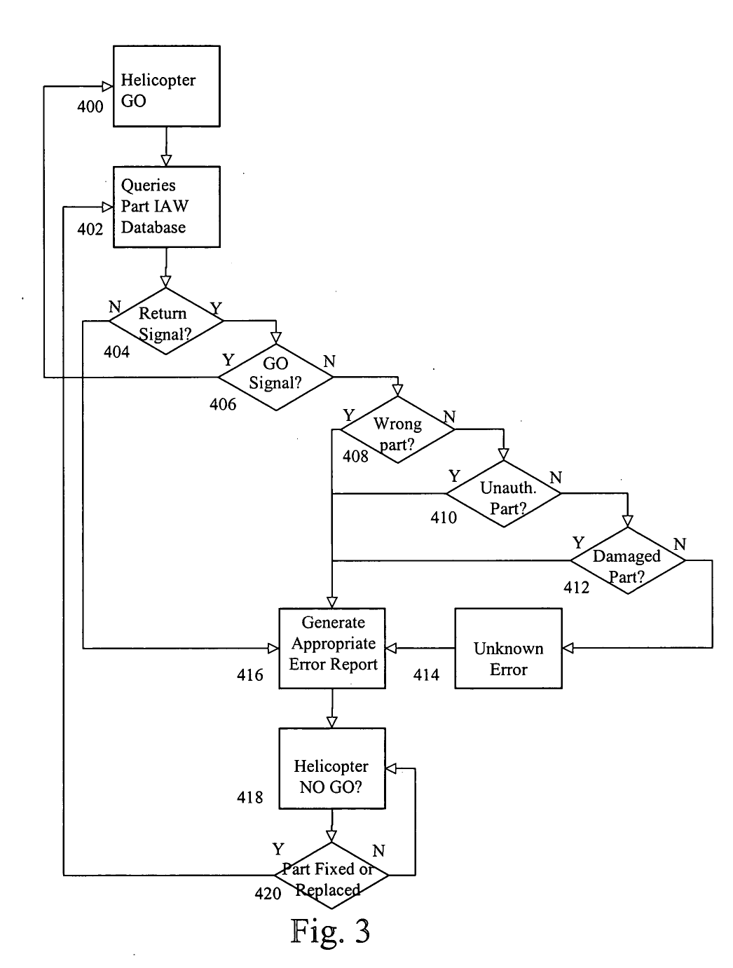

Referring to FIG. 3, which shows the decision tree of the helicopter integrated part tracking system. Starting at block 400 the helicopter is in a “go” status. The helicopter queries the parts with the part tracking device in accordance with a stored part tracking database 402. If system must make a decision in block 404 whether there is a return signal. If there is, it must decide whether there is a “go” signal 406. If yes, then the helicopter is a go, block 400, and the cycle repeats.

If at block 406 there was no “go” signal, the system asks whether it was the wrong part 408 or an unauthorized part 410 or a damaged part 412. If the answer to all three are “no” then an unknown error is created at block 414 or if the answer to blocks 408, 410 or 412 is “yes” or if the re is no return signal 404, then an appropriate error report is created at block 416. The helicopter then goes to a “no go” status 418. The status stays until the part is fixed or replaced 420. When it is then the system is reset and the helicopter is in a “go” status again.

This system may be used in flight or on the ground to aid the pilots or mechanics in diagnosing in-flight or maintenance problems. If a problem is found, the system could be designed to prevent the take-off or start-up until the problems are fixed.

Preferably the part tracking system is programmable so that as parts are replaced and new parts are substituted for the old parts, the system recognizes the new parts as correct, fully functional parts.

By implementing the part tracking system, the owner, operator and manufacturer can ensure that only authorized parts are installed ensuring the highest levels of safety and preventing confusion over which manufacturer supplied the part and its history.

Further yet it should be understood that the foregoing relates only to preferred embodiments of the present invention, and that numerous changes and modifications may be made therein without departing from the spirit and scope of the invention as defined in the following claims.

1. A part tracking device system comprising a part, a part tracking device embedded in the part, a magnetic field detector that passes over the part and creates a signal and compares that signal to a signal stored in a database corresponding to the part and creates an output based on the comparison.

2. A part tracking device system according to claim 1, wherein the part tracking device is an irregularly shaped metallic object.

3. A part tracking device system according to claim 1, wherein the part tracking device comprises a material different than the part.

4. A part tracking device system according to claim 1, wherein the magnetic field detector comprises multiple coils of wire.

5. A part tracking device system according to claim 1, wherein the magnetic field detector comprises a magnetic field generator.

6. A part tracking device system according to claim 1, wherein the part tracking device system comprises a display for showing the results of the magnetic field detector scan.

7. A method for tracking parts comprising the steps of querying at least one part from data in a database about parts on a helicopter, checking if there is a return signal, and determining whether the part is the correct part.

8. A method for tracking parts according to claim 7, further comprising the step of checking whether the part is authorized.

9. A method for tracking parts according to claim 8, further comprising the step of checking whether the part is damaged.

10. A method for tracking parts according to claim 9, further comprising the step generating an error report.

11. A method for tracking parts according to claim 10, further comprising the step preventing the helicopter from restarting if a wrong part, unauthorized part or a damaged part is installed on the helicopter.

12. A part tracking system comprising a generator, a processor and an electronic part tracking device attached to a part wherein the electronic part tracking device comprises a signal pickup, a signal generator, and a signal return.

13. A part tracking system according to claim 12, wherein the part tracking device is attached to the part so that any removal of the part tracking device destroys the part tracking device.

14. A part tracking system according to claim 13, wherein the part tracking device contains information including part installation date and part maintenance information.

15. A part tracking system according to claim 14, wherein part tracking device uses magnetic fields to transfer signals.

16. A part tracking system according to claim 14, wherein part tracking device uses radio frequencies to transfer signals.

17. A part tracking system according to claim 14, wherein part tracking device has a unique physical serial number attached.

18. A part tracking system according to claim 12, wherein the generator and the processor are contained in the same portable housing.

19. A part tracking system according to claim 12, wherein the generator comprises a test button, an On/Off switch, a signal transmitter and a power source.

20. A part tracking system according to claim 12, wherein the processor comprises an output, a display, a filter and a control unit.
